(19) United States
(12) Patent Application Publication
(10) Pub. No.: US 2010/0182885 A1
(43) Pub. Date: Jul. 22, 2010

(54) METHOD FOR DISCRIMINATING OPTICAL DISC, OPTICAL DISC DEVICE AND PROGRAM

(75) Inventors: Akihiro Fukumoto, Machida (JP); Tsutomu Arai, Hachiouji (JP)

Correspondence Address: Robinson Intellectual Property Law Office, P.C., 3975 Fair Ridge Drive, Suite 20 North, Fairfax, VA, 22033, US

(73) Assignee: KABUSHIKI KAISHA KENWOOD, Hachiouji-shi, Tokyo (JP)

(21) Appl. No.: 12/602,587

(22) PCT Filed: Jan. 30, 2009
(86) PCT No.: PCT/JP2009/051549

§ 371 Date: Dec. 1, 2009

(30) Foreign Application Priority Data
Jan. 31, 2008 (JP) 2008-021171
Jan. 31, 2008 (JP) 2008-021176
Jan. 31, 2008 (JP) 2008-021185

(51) Int. Cl. G11B 7/00

(52) U.S. Cl. 369/53.22; G9B/7

(57) ABSTRACT

Provided is a method for easily discriminating that a disc is a blank disc that conforms to the DVD Download standards. An optical disc device is provided with a first identifying means (4) which identifies disc information written in a lead-in zone of an optical disc (1); a second identifying means (4) which identifies that there is no data recorded in the data zone of the optical disc (1); and a discriminating means (5) which discriminates that the optical disc is a blank disc that conforms to the DVD Download standards, based on output from the first identifying means and output which is outputted from the second identifying means and indicating that there is no data recorded.

### TECHNICAL FIELD

The present invention relates to a method for discriminating optical discs, and an optical disc device and a program for realizing the discriminating method.

### BACKGROUND ART

With various standards already created for DVD (Digital Versatile Disc), an optical disc format, new standards are still set in accordance with new varieties of DVD. For this reason, the types of DVD need to be discriminated when a DVD is loaded into an optical disc device. As techniques for discriminating the types of DVD, proposals disclosed in the patent documents below are known.

Patent Document 1: Japanese Patent Application Laid-Open No. 2004-246990

Patent Document 2: Japanese Patent Application Laid-Open No. 2000-315355

### DISCLOSURE OF THE INVENTION

### Problems to be Solved by the Invention

DVD Download standards are proposed as new standards of DVD. The DVD Download standards are based on the assumptions that a service provider or the like authorized by a content supplier records content on DVDs and supplies them to consumers, or that a provider authorized by a content supplier burns or otherwise writes content onto a DVD blank disc purchased by a user, instead of the assumption that a content supplier provides DVDs for consumers.

The DVD Download standards involve a standard (standard of EST2) stipulating that control signals for protecting copyright such as for preventing illegal copy and for preventing illegal reproduction of content must be recorded in the control data zone (an area for recording control information; almost synonymous with an after-mentioned lead-in zone) of a DVD in advance.

Specifically, in the control data zone, four items of information below are written:
1) Book Type
2) Compatible Part Version
3) Disc Indicator
4) Maximum Recorded Address

If DVD-ROM is written in Book Type in the control data zone, it is logically recognized that the disc is a DVD-ROM and it is assumed that there is data recorded in the data zone.

Accordingly, if a blank disc, which has no data recorded in the data zone, is loaded in an optical disc reproducing device, the optical disc reproducing device reads the information from the control data zone and logically recognizes that the blank disc is a DVD-ROM based on the entry for Book Type. Then, the optical disc reproducing device seeks the data zone and proceeds to read processing on data assumed to be recorded therein.

The optical disc reproducing device cannot read any data when it proceeds to the reading operation, however, because the blank disc has no data recorded in the data zone. It may cause the optical disc reproducing device to run into an infinite loop in which a data-reading operation continues infinitely. Or, it may cause a data processing device side to have such malfunctions as mistaking the absence of data to be read for the occurrence of a failure.

The present invention solves the above-mentioned problems and has an object of easily discriminating that a disc is a blank disc that conforms to the DVD Download standards with no data to be read in the data zone.

### Means for Solving the Problems

According to the first aspect of the present invention, the present invention is an optical disc discriminating method for discriminating types of loaded optical disc, characterized by judging that the optical disc is a blank disc that conforms to DVD Download standards when it is logically detected that the optical disc is a DVD-ROM based on disc information written in a lead-in zone of the optical disc and it is also detected that there is no data recorded in a data zone of the optical disc.

When a tracking error signal with a predetermined or greater amplitude is not detected in the data zone, it can be judged that there is no data recorded in the data zone.

When it is controlled to perform tracking-on on the data zone but the tracking-on fails, it can be judged that there is no data recorded in the data zone.

The logical detection of being a DVD-ROM can be performed based on Book Type written in the control data zone in the lead-in zone of the optical disc.

According to the second aspect of the present invention, the present invention is an optical disc device for recording and/or reproducing information in a loaded optical disc, characterized by comprising: a first identification means which logically identifies that the optical disc is a DVD-ROM based on information written in a lead-in zone of the optical disc; a second identification means which identifies that there is no data recorded in a data zone of the optical disc; and a discrimination means which judges that the optical disc is a blank disc that conforms to DVD Download standards, based on output from the first identification means indicating that the optical disc is logically a DVD-ROM and output from the second identification means indicating that there is no data recorded in the data zone.

When a tracking error signal with a predetermined or greater amplitude cannot be detected, the second identification means can judge that there is no data recorded in the data zone.

When it is controlled to perform tracking-on on the data zone but the tracking-on fails, the second identification means can judge that there is no data recorded in the data zone.

The logical identification of being a DVD-ROM can be performed based on Book Type written in the control data zone in the lead-in zone of the optical disc.

According to the third aspect of the present invention, the present invention is a program for causing an information processing device to realize functions of the first identification means, the second identification means, and the discrimination means when the program is installed in the information processing device.

According to the fourth aspect of the present invention, the present invention is an optical disc discriminating method for discriminating types of loaded optical disc, characterized by judging that an optical disc is a blank disc that conforms to DVD Download standards when it is logically detected that the optical disc is a DVD-ROM based on disc information written in a lead-in zone of the optical disc, and also determined that tracking-on fails as a result of performing a tracking operation instruction on a data zone of the optical disc, and also determined that no tracking error signal is detected as a result of performing focus-on on the data zone.

Among areas in the data zone of the optical disc, a start address area therein can be subjected to the focus-on.

The tracking operation can be performed while moving in the radial direction of the optical disc.

According to the fifth aspect of the present invention, the present invention is an optical disc device for recording and/or reproducing information in a loaded optical disc, characterized by comprising: a first identification means which logically identifies that the optical disc is a DVD-ROM based on disc information written in a lead-in zone of the optical disc; a tracking control means which controls to perform tracking-on on a data zone of the optical disc, and, if it is determined that the tracking-on fails, outputs an indication that the tracking-on fails; a second identification means which judges whether it is with or without a tracking error signal by performing focus-on on the data zone of the optical disc in response to the output that the tracking-on fails from the tracking control means; and a discrimination means which judges that the optical disc is a blank disc that conforms to the DVD Download standards, based on an output from the first identification means logically indicating that the optical disc is a DVD-ROM and the output from the second identification means indicating absence of the tracking error signal.

Among areas in the data zone of the optical disc, a start address area therein can be subjected to the focus-on.

The tracking control means can control to perform the tracking-on on the optical disc while moving in the radial direction thereof.

According to the sixth aspect of the present invention, the present invention is an optical disc discriminating method for discriminating types of loaded optical disc, characterized by judging that the optical disc is a blank disc that conforms to DVD Download standards, if it is logically detected that the optical disc is a DVD-ROM based on information written in a lead-in zone of the optical disc and no tracking error signal is detected in the data zone, followed by detecting a wobble signal, and if it is also recognized that a wobble groove is present in the optical disc.

If no tracking error signal is detected in the data zone by a differential phase detection method, a push-pull detection approach can be applied for detecting a wobble signal.

According to the seventh aspect of the present invention, the present invention is an optical disc device for recording and/or reproducing information in a loaded optical disc, characterized by comprising: a first identification means which logically identifies that the optical disc is a DVD-ROM based on information written in a lead-in zone of the optical disc; a second identification means which detects a tracking error signal in a data zone of the optical disc by the differential phase detection method when the first identification means logically identifies that the optical disc is the DVD-ROM; a third identification means which detects a wobble signal in the data zone by the push-pull detection approach when the second identification means detects no tracking error signal; and a discrimination means which discriminates that the optical disc is a blank disc that conforms to the DVD Download standards when the third identification means detects the wobble signal.

### Effects of the Invention

According to the present invention, a blank disc that conforms to DVD Download standards can be easily discriminated from others, thereby preventing malfunctions.

### BRIEF DESCRIPTION OF THE DRAWINGS

FIG. 1 is a diagram showing a partial configuration of an optical disc device according to a first embodiment of the present invention;

FIG. 2 is a flowchart showing the process of the first embodiment of the present invention;

FIG. 3 is a diagram showing a partial configuration of an optical disc device according to a second embodiment of the present invention;

FIG. 4 is a flowchart showing the process of the second embodiment of the present invention;

FIG. 5 is a diagram showing a partial configuration of an optical disc device according to a third embodiment of the present invention; and

FIG. 6 is a flowchart showing the process of the third embodiment of the present invention.

### DESCRIPTION OF SYMBOLS

1 DVD
2 motor
3 optical pickup
4 signal processing/servo control unit (first identification means, second identification means)
5 disc discrimination unit (disc discrimination means)

### BEST MODES FOR CARRYING OUT THE INVENTION

Embodiments of the present invention will be described below with reference to the drawings.

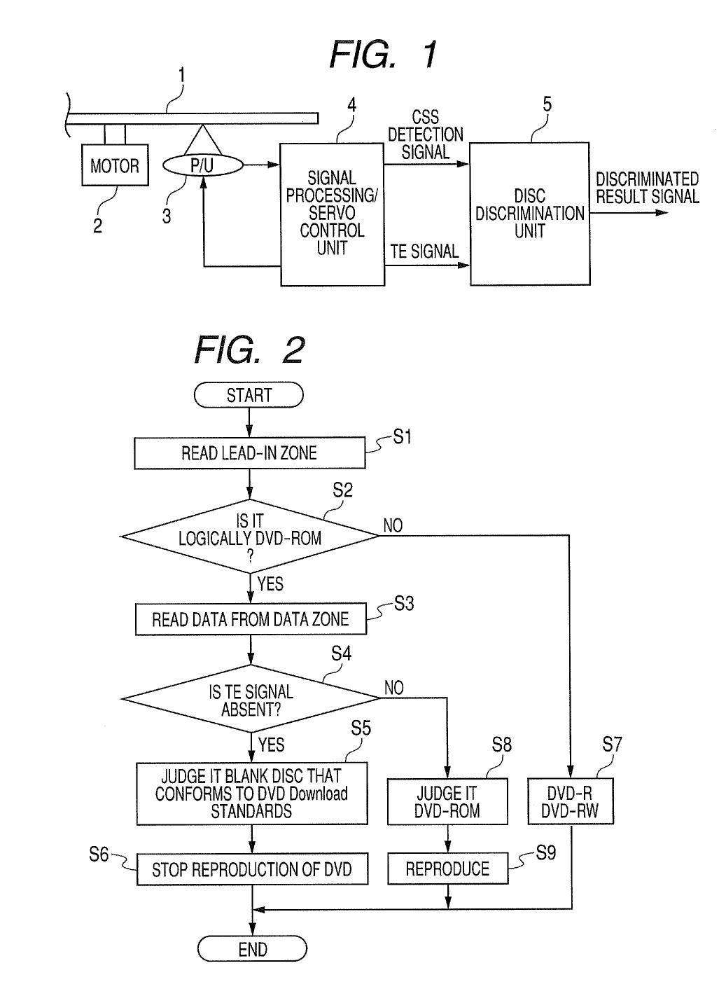

FIG. 1 shows a partial configuration of an optical disc device according to a first embodiment. This optical disc device exemplifies a reproducing device that reads data recorded on a loaded. DVD 1 via an optical pickup (denoted by P/U in FIG. 1) 3 by rotating the DVD 1 with a motor 2.

The optical pickup 3 is connected to a signal processing/servo control unit 4 which processes a signal read and servo controls the optical pickup 3 based on the processed signal. The signal processing/servo control unit 4 has a signal processing function of processing the signal read via the optical pickup 3 and outputting the processed result, and a servo controlling function of servo controlling the optical pickup 3 with respect to focusing and tracking based on the signals read. The signal processing function includes functions of processing signals read from a lead-in zone and a data zone and outputting the processed results, such as functions of detecting/outputting Book Type information, detecting/outputting other control signals, and detecting/outputting a tracking error signal. The signal processing/servo control unit 4 has functions of RF front-end and a digital signal processing, and servo controlling functions of providing servo control signals for a focus servo actuator and a tracking servo actuator of the optical pickup 3.

The signal processing/servo control unit 4 corresponds to a first identification means and a second identification means by an aspect of identifying disc information written in the lead-in zone and an aspect of identifying that no data is recorded in the data zone, respectively.

The disc discrimination unit 5 is means for receiving a disc information detection signal and a TE (tracking error) detection signal output from the signal processing/servo control unit 4, discriminating the types of DVD 1, and outputting the discrimination. If it is judged that the loaded DVD 1 is a blank disc that conforms to the DVD Download standards according to the discrimination output, the optical disc reproducing device can stop the reading operation on the DVD 1 to perform a stop reproduction operation or DVD 1 ejection.

Now, a discrimination method according to the first embodiment of the optical disc will be described with reference to the flowchart shown in FIG. 2.

FIG. 2 is a flowchart showing the process of, after it is discriminated that the loaded optical disc is the DVD 1, judging that the DVD 1 conforms to download standards and is a blank disc with no data written in the data zone.

First, the optical disc device reads the lead-in zone by causing the optical pickup 3 to seek the lead-in zone at the inner circumference side of the DVD 1 in which control data is recorded (step S1). The signal processing/servo control unit 4 discriminates logical disc information by reading Book Type written in the control data zone in the lead-in zone (step S2). If disc information other than DVD-ROM is written in Book Type, such as DVD-R or DVD-RW, it is judged that the optical disc is any of the types of disc (step S7).

On the other hand, when it is detected that Book Type is DVD-ROM, it is logically determined that the DVD 1 is a DVD-ROM; therefore, the optical disc device reads the data from the data zone by moving the optical pickup 3 to the data zone (step S3). For example, since the start address of the data zone is 30000h, reading of the data starts at 30000h. At this moment, the signal processing/servo control unit 4 also discriminates whether it is with or without a tracking error signal by trying to detect the tracking error signal using the DPD (Differential Phase Detection) method (step S4). As a result of the discrimination, if a tracking error signal that exceeds a predetermined amplitude (level) is not detected, the signal processing/servo control unit 4 outputs that the tracking error signal is absent to the disc discrimination unit 5.

When it is detected that Book Type is DVD-ROM in the lead-in zone and no tracking error signal is detected in the data zone, the disc discrimination unit 5 judges that the loaded DVD 1 is a blank disc that conforms to the DVD Download standards (step S5). According to the judgment that it is the blank disc, the optical disc device stops the reproduction operation or performs such processing as ejection (step S6).

On the other hand, if the tracking error signal is detected as a result of the discrimination in step S4, data is recorded in the data zone; therefore, it is judged that the DVD 1 is a DVD-ROM (step S8), and the process proceeds to the reproduction operation (step S9).

When data is recorded in the data zone, the content of the data is recorded in each track as a pit which indicates “1” or “0”; therefore, when the pit is detected, the tracking error signal is generally detected as a saw-tooth waveform with an amplitude fluctuation of a predetermined width, for example an output variation width by several hundreds millivolts. If data is not recorded in the data zone, however, no pit is formed thereon; therefore, only a weak signal can be detected as the tracking error signal. For this reason, if no signal but those at levels where no pit is formed can only be detected as the tracking error signals in a blank disc, the signal processing/servo control unit 4 outputs that no tracking error signal is detected.

The signal processing/servo control unit 4 can also judge that no data is recorded by merely performing a tracking operation instruction (tracking-on) as a method of detecting that no data is recorded in the data zone, and having a result that the tracking-on fails (tracking-off); instead of performing a tracking error signal detection instruction and determining that no tracking error signal is detected based on whether the level of the tracking error signal reaches a predetermined range or not.

Data reading control is performed by performing the tracking servo control and the focus servo control, because it is logically determined that it is the DVD-ROM based on the record of Book Type in the lead-in zone. Since a blank disc has no data recorded, however, no tracking error signal for performing the tracking servo control can be obtained, thereby only the focus servo control is performed which does not make the tracking on (the tracking servo control is not turned on); therefore, it can be judged that no data is in the data zone. This judgment is advantageous in such simplicity that it can be determined based on the behavior of the tracking servo control without comparing the amplitude levels of the tracking error signals.

Although the first embodiment has been described by an example of detecting disc information from the lead-in zone at first, which is followed by detecting whether the data zone is with or without the tracking error signals, the order of the detection may be reversed.

The invention of discriminating that it is a blank disc that conforms to the DVD Download standards based on detection of the disc information in the lead-in zone and whether the data zone is with or without the data record can also be realized by installing a control program in the information processing device. When a control program for realizing a function of identifying disc information in the lead-in zone, a function of identifying whether the data zone is with or without the data record, and a function of discriminating that it is a blank disc that conforms to the DVD Download standards based on both of the identified results is installed as a part of disc discriminating software of the conventional DVD reproducing device, the DVD reproducing machine can discriminate that it is a blank disc that conforms to the DVD Download standards. The control program can be easily installed in the information processing device via a recording medium such as a CD-ROM with the program recorded thereon. Alternatively, the control program can be installed in the information processing device over a network.

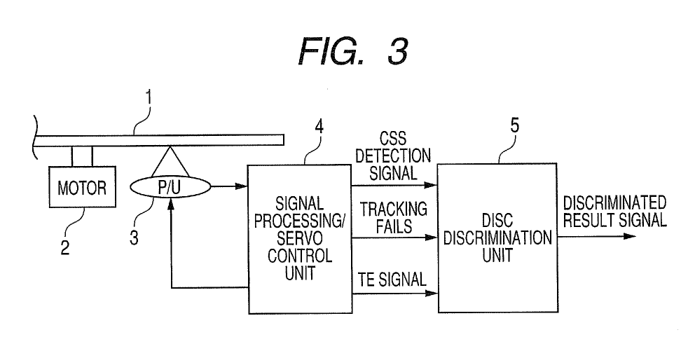

FIG. 3 shows a partial configuration of an optical disc device according to a second embodiment. This optical disc device exemplifies a reproducing device that reads data recorded on the loaded DVD 1 via the optical pickup (denoted by P/U in FIG. 3) 3 by rotating the DVD 1 with the motor 2.

The optical pickup 3 is connected to the signal processing/servo control unit 4 which processes a signal read and servo controls the optical pickup 3 based on the processed signal. The signal processing/servo control unit 4 has a signal processing function of processing the signal read via the optical pickup 3 and outputting the processed result, and a servo controlling function of servo controlling the optical pickup 3 with respect to focusing and tracking based on the signals read. The signal processing/servo control unit 4 has functions of detecting/outputting Book Type information, detecting/outputting other control signals, and detecting/outputting a tracking error signal. The signal processing/servo control unit 4 has functions of RF front-end and a digital signal processing, and servo controlling functions of providing servo control signals for the focus servo actuator and the tracking servo actuator of the optical pickup 3.

The signal processing/servo control unit 4 corresponds to a first identification means, a tracking control means, and a second identification means by an aspect of identifying disc information written in the lead-in zone, an aspect of performing a tracking operation instruction on the optical disc, and, when it results in the tracking failure, outputting that the tracking-on fails, and an aspect of receiving the output that the tracking-on fails and detecting whether the data zone is with or without the tracking error signal by focusing on the data zone, respectively.

The disc discrimination unit 5 is a discrimination means for receiving a disc information detection signal, a signal indicating that the tracking-on fails, and a TE (tracking error) detection signal output from the signal processing/servo control unit 4, discriminating the types of DVD 1, and outputting the discrimination. If it is judged that the loaded DVD 1 is a blank disc that conforms to the DVD Download standards according to the discrimination output, the optical disc reproducing device can stop the reading operation on the DVD 1 to perform the stop reproduction operation or DVD 1 ejection.

Now, a discrimination method according to the second embodiment of the optical disc will be described with reference to the flowchart shown in FIG. 4.

FIG. 4 is a flowchart showing the process of, after it is discriminated that the loaded optical disc is the DVD 1, judging that the DVD 1 conforms to DVD Download standards and is a blank disc with no data written in the data zone.

First, the optical disc device reads the lead-in zone by causing the optical pickup 3 to seek the lead-in zone at the inner circumference side of the DVD 1 in which control data is recorded (step S11). The signal processing/servo control unit 4 discriminates logical disc information by reading Book Type written in the control data zone in the lead-in zone (step S12). If disc information other than DVD-ROM is written in Book Type, such as DVD-R or DVD-RW, it is judged that the optical disc is any of the types of disc (step S19).

On the other hand, when it is detected that Book Type is DVD-ROM, it is logically determined that the DVD 1 is a DVD-ROM; therefore, the signal processing/servo control unit 4 performs the tracking operation instruction by controlling the optical pickup 3 to move to the data zone (step S13). The tracking operation is performed by seeking the optical pickup 3 in the radial direction of the optical disc 1. The signal processing/servo control unit 4 discriminates whether the tracking can be performed or not from the result of the tracking operation instruction (step S14). If it comes out that the tracking-on fails (tracking failure), the signal processing/servo control unit 4 outputs a signal to that effect to the disc discrimination unit 5. The signal processing/servo control unit 4 focuses on a predetermined area of the data zone and reads data from the data zone (step S15). If the predetermined area starts from the start address of the data zone, 30000h, or placed in the outermost circumference track, for example, the focus-on is fixedly addressed; which is advantageous in simplifying control of detecting the tracking error signals.

The signal processing/servo control unit 4 discriminates whether it is with or without a tracking error signal by trying to detect the tracking error signal starting from a predetermined address by using the DPD (Differential Phase Detection) method (step S16). As a result of the discrimination, if a tracking error signal that exceeds a predetermined amplitude (level) is not detected, the signal processing/servo control unit 4 outputs that the tracking error signal is absent to the disc discrimination unit 5.

When it is detected that Book Type is DVD-ROM in the lead-in zone, the tracking fails, and no tracking error signal is detected when a predetermined area of the data zone is focused on, the disc discrimination unit 5 judges that the loaded DVD 1 is a blank disc that conforms to the DVD Download standards (step S17). According to the judgment that the DVD 1 is a blank disc, the optical disc device stops the reproduction operation or performs such processing as ejection (step S18). If the tracking error signal is detected in step S16, or if the tracking-on is performed without resulting in the tracking-off in step S14, data is recorded in the data zone; therefore, it is judged that the DVD 1 is a DVD-ROM (step S20), and the process proceeds to the reproduction operation (step S21).

When data is recorded in the data zone, the content of the data is recorded in each track as a pit which indicates “1” or “0”; therefore, when the pit is detected, the tracking error signal is generally detected as a saw-tooth waveform with an amplitude fluctuation of a predetermined width, for example an output variation width by several hundreds millivolts. If data is not recorded in the data zone, however, no pit is formed thereon; therefore, only a weak signal can be detected as the tracking error signal. For this reason, if no signal but those at levels where no pit is formed can only be detected as the tracking error signals in a blank disc, the signal processing/servo control unit 4 outputs that no tracking error signal is detected.

Since the second embodiment proceeds in the order of: detecting disc information in the lead-in zone; and then, performing the tracking operation instruction (tracking-on) once; and if the tracking-on fails (tracking failure), performing the focus-on on the data zone to detect the tracking error signals, it is advantageous in certainly detecting that data is not recorded in the data zone.

The invention of discriminating that it is a blank disc that conforms to the DVD Download standards by focusing on the data zone to detect the tracking error signals when the disc information is detected in the lead-in zone and the tracking on the data zone fails can also be realized by installing a control program in the information processing device. When a control program for realizing an identification function of identifying disc information in the lead-in zone, a tracking control function of outputting that the tracking fails in response to the tracking operation instruction, a tracking error signal identification function of focusing on a predetermined area of the data zone to detect whether the data zone is with or without the tracking error signal in response to the output that the tracking fails from the tracking control means, and a discrimination function of discriminating that it is a blank disc that conforms to the DVD Download standards based on these outputs is installed as a part of disc discriminating software of the conventional DVD reproducing device, the DVD reproducing machine can discriminate that it is a blank disc that conforms to the DVD Download standards. The control program can be easily installed in the information processing device via a recording medium such as a CD-ROM with the program recorded thereon. Alternatively, the control program can be installed in the information processing device over a network.

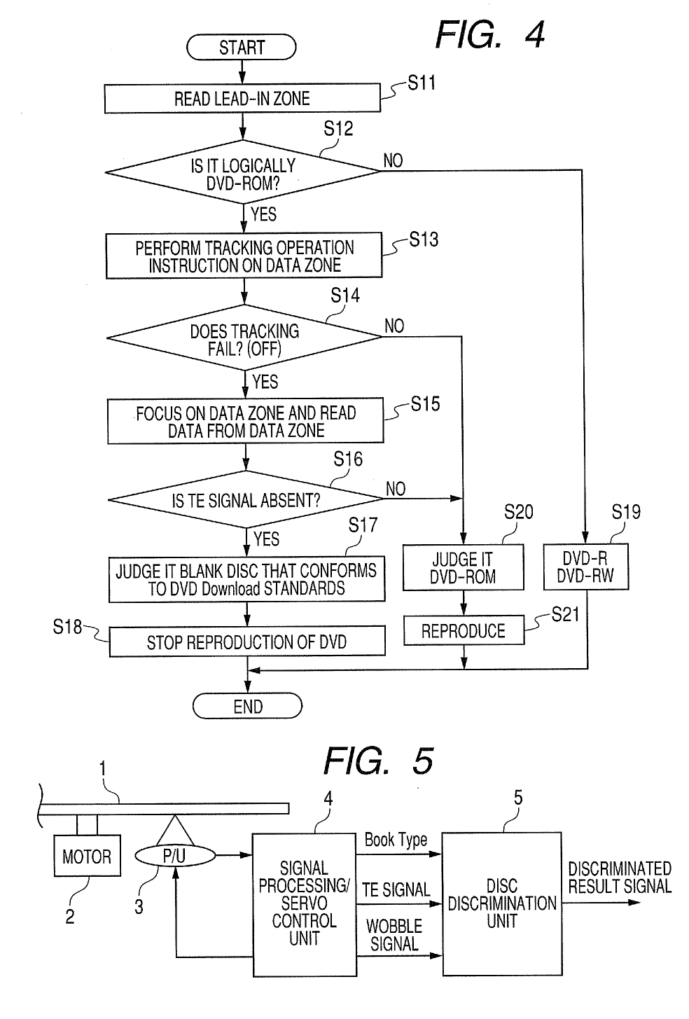

FIG. 5 shows a partial configuration of an optical disc device according to a third embodiment. FIG. 5 exemplifies a reproducing device that reads data recorded on the loaded DVD 1 via the optical pickup (denoted by P/U in FIG. 5) 3 by rotating the DVD 1 with the motor 2.

The optical pickup 3 is connected to the signal processing/servo control unit 4 which processes a signal read and servo controls the optical pickup 3 based on the processed signal. The signal processing/servo control unit 4 has a signal processing function of processing the signal read via the optical pickup 3 and outputting the processed result, and a servo controlling function of servo controlling the optical pickup 3 with respect to focusing and tracking based on the signals read. The signal processing function includes functions of processing signals read from a lead-in zone and a data zone and outputting the processed results, such as functions of detecting/outputting a signal detected in the control data to the effect that the disc is logically a DVD-ROM, detecting/outputting other control signals, detecting/outputting a tracking error signal, and detecting/outputting a wobble signal. The signal processing/servo control unit 4 has functions of RF front-end and a digital signal processing, and servo controlling functions of providing servo control signals for a focus servo actuator and a tracking servo actuator of the optical pickup 3.

The signal processing/servo control unit 4 corresponds to a first identification means, a second identification means, and a third identification means by an aspect of identifying the information recorded in the lead-in zone that it is logically a DVD-ROM, by an aspect of detecting the tracking error signal in the data zone by using the differential phase detection method, and by an aspect of detecting the wobble signal by using the push-pull detection approach if no tracking error signal is detected, respectively.

The disc discrimination unit 5 is a discrimination means for receiving a detection signal to the effect that the DVD 1 is logically a DVD-ROM, a TE (tracking error) detection signal, and detection signal to the effect that a wobble groove is present which are output from the signal processing/servo control unit 4, discriminating the types of DVD 1, and outputting the discrimination. If it is judged that the loaded DVD 1 is a blank disc that conforms to the DVD Download standards according to the discrimination output, the optical disc reproducing device can stop the reading operation on the DVD 1 to perform the stop reproduction operation or DVD 1 ejection.

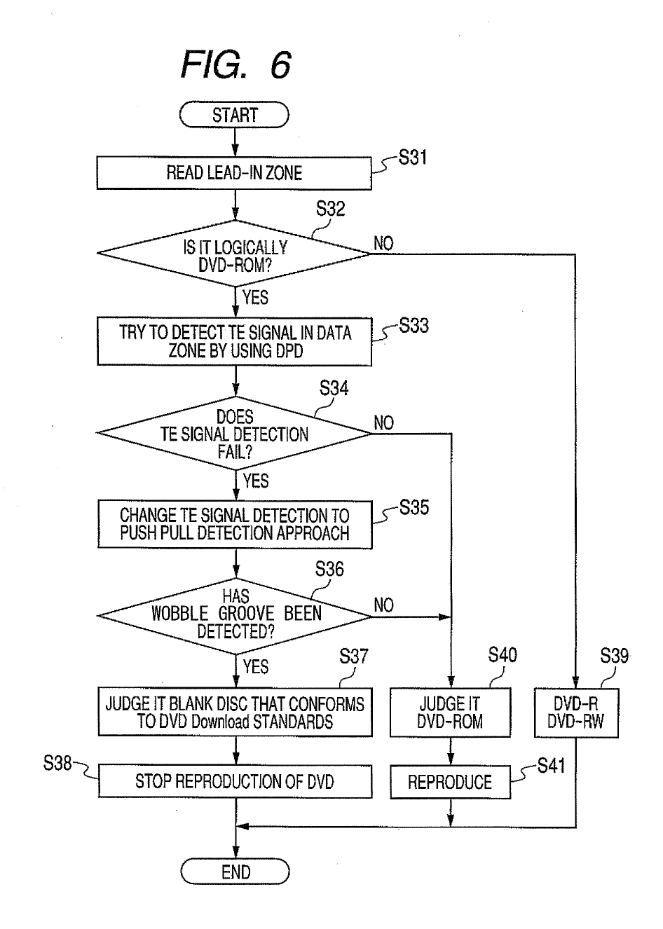

Now, a discrimination method according to the third embodiment of the optical disc will be described with reference to the flowchart shown in FIG. 6.

FIG. 6 is a flowchart showing the process of, after it is discriminated that the loaded optical disc is a DVD, judging that the DVD 1 is a DVD that conforms to DVD Download standards and is a blank disc with no data written in the data zone.

First, the optical disc device reads the lead-in zone by causing the optical pickup 2 to seek the lead-in zone at the inner circumference side of the DVD 1 in which control data is recorded (step S31). It judges whether the information that the optical disc is logically a DVD-ROM is detected in the lead-in zone or not (step S32). Whether the disc is logically a DVD-ROM or not can be determined by whether the information that the disc is a DVD-ROM is loaded as the information on Book Type in the lead-in zone or not.

If disc information other than DVD-ROM is written in Book Type in the lead-in zone of the DVD 1, a test object, such as DVD-R or DVD-RW, it is judged that the optical disc is any of the types of disc (step S39).

According to the discrimination that the DVD 1, the test object, is logically a DVD-ROM, it is determined that the DVD 1 records data as a DVD-ROM; therefore, the optical disc device reads the data in the data zone by moving the optical pickup 3 to the data zone (step S33). For example, since the start address of the data zone is 30000h, reading of the data starts at 30000h. At this moment, the signal processing/servo control unit 4 also tries to detect the tracking error signal (TE signal) by using the DPD (Differential Phase Detection) method, and if a tracking error signal that exceeds a predetermined amplitude (level) is not detected, the signal processing/servo control unit 4 outputs that the tracking error signal is absent to the disc discrimination unit 5 (step S34).

When data is recorded in the data zone, the content of the data is recorded in each track as a pit which indicates “1” or “0”; therefore, when the pit is detected, the tracking error signal is generally detected as a saw-tooth waveform with an amplitude fluctuation of a predetermined width, for example an output variation width by several hundreds millivolts. If data is not recorded in the data zone, however, no pit is formed thereon; therefore, only a weak signal can be detected as the tracking error signal. If no signal but those at levels where no pit is formed can only be detected as the tracking error signals, the signal processing/servo control unit 4 outputs that a tracking error signal is absent.

If signal processing/servo control unit 4 cannot detect the tracking error signal by using DPD, it retries to detect the tracking error after changing the tracking error detection method to the push-pull detection approach, and judges whether a wobble groove is present or not by trying to detect wobble signals in the output from predetermined band path filters (steps S35, S36). In the DVD Download standards, the wobble frequency is defined as about twice the frequency of general DVD-R. Accordingly, the wobble groove can be detected with band path filters for detecting a wobble groove with respect to a conventional DVD-R. On the other hand, there is no wobble groove (wobble frequency) in the DVD-ROM. Therefore, if it is logically determined that the loaded DVD 1 is a DVD-ROM and the wobble groove is detected, the DVD 1 is identified as a blank disc that conforms to the DVD Download standards. If no wobble groove is present, it can be judged as a DVD-ROM.

According to the output to the effect that it is a DVD-ROM, the output to the effect that no tracking error signal is detected, and the output to the effect that the wobble signal is detected, the disc discrimination unit 5 judges that the DVD 1, the test object, is a blank disc that conforms to the DVD Download standards (step S37). According to the judgment that the DVD 1 is the blank disc, the reproduction operation of the disc is stopped or such processing as ejection is performed (step S38). If the tracking error signal is detected or if the wobble signal is not detected, the DVD 1 is judged as a DVD-ROM (step S40), and the process proceeds to the reproduction operation (step S41).

According to the third embodiment, whether the DVD 1 is a blank disc that conforms to the DVD Download standards or not can be certainly discriminated.

When a control program for realizing an identification function of information to the effect that the disc, the test object, is logically a DVD-ROM, an identification function of whether it is with or without the tracking error signal by using DPD, an identification function of whether the wobble groove is present or not, and a discrimination function of discriminating that it is a blank disc that conforms to the DVD Download standards based on the identification results is installed, the DVD reproducing device can discriminate that it is a blank disc that conforms to the DVD Download standards, thereby discriminate as a blank disc that conforms to the DVD Download standards without causing any malfunction. The control program can be easily installed in the information processing device via a recording medium such as a CD-ROM with the program recorded thereon. Alternatively, the control program can be installed in the information processing device over a network.

Although the above-mentioned embodiments have been described by taking example of a DVD reproduction device, the embodiments can also be implemented by a DVD recording device.

1. An optical disc discriminating method for discriminating types of loaded optical discs, characterized by
judging that an optical disc is a blank disc that conforms to DVD Download standards when it is logically detected that the optical disc is a DVD-ROM based on disc information written in a lead-in zone of the optical disc and it is also detected that there is no data recorded in a data zone of the optical disc.

2. The optical disc discriminating method according to claim 1, wherein when a tracking error signal with a predetermined or greater amplitude is not detected in the data zone, it can be judged that there is no data recorded in the data zone.

3. The optical disc discriminating method according to claim 1, wherein when it is controlled to perform tracking-on on the data zone but the tracking-on fails, it can be judged that there is no data recorded in the data zone.

4. The optical disc discriminating method according to any one of claims 1 to 3, wherein the logical detection of being a DVD-ROM can be performed based on Book Type written in the control data zone in the lead-in zone of the optical disc.

5. An optical disc device for recording and/or reproducing information in a loaded optical disc, the optical disc device comprising:
first identification unit adapted to logically identify that the optical disc is a DVD-ROM based on information written in a lead-in zone of the optical disc;
second identification unit adapted to identify that there is no data recorded in a data zone of the optical disc; and
discrimination unit adapted to judge that the optical disc is a blank disc that conforms to DVD Download standards, based on output from the first identification unit indicating that the optical disc is logically a DVD-ROM and output from the second identification unit indicating that there is no data recorded in the data zone.

6. The optical disc device according to claim 5, wherein when a tracking error signal with a predetermined or greater amplitude cannot be detected, the second identification unit can judge that there is no data recorded in the data zone.

7. The optical disc device according to claim 5, wherein when it is controlled to perform tracking-on on the data zone but the tracking-on fails, the second identification unit can judge that there is no data recorded in the data zone.

8. The optical disc device according to any one of claims 5 to 7, wherein the logical identification of being a DVD-ROM can be performed based on Book Type written in the control data zone in the lead-in zone of the optical disc.

9. A program for causing an information processing device to realize functions of the first identification unit, the second identification unit, and the discrimination unit according to claims 5 to 7, when the program is installed in the information processing device.

10. An optical disc discriminating method for discriminating types of loaded optical discs, characterized by
judging that an optical disc is a blank disc that conforms to DVD Download standards when it is logically detected that the optical disc is a DVD-ROM based on disc information written in a lead-in zone of the optical disc, and also determined that tracking-on fails as a result of performing a tracking operation instruction on a data zone of the optical disc, and also determined that no tracking error signal is detected as a result of performing focus-on on the data zone.

11. The optical disc discriminating method according to claim 10, wherein among areas in the data zone of the optical disc, a start address area therein can be subjected to the focus-on.

12. The optical disc discriminating method according to claim 10, wherein the tracking operation is performed while moving in the radial direction of the optical disc.

13. An optical disc device for recording and/or reproducing information in a loaded optical disc, the optical disc device comprising:
first identification unit adapted to logically identify that the optical disc is a DVD-ROM based on disc information written in a lead-in zone of the optical disc;
tracking control unit adapted to control tracking-on on a data zone of the optical disc, and, if it is determined that the tracking-on fails, outputs an indication that the tracking-on fails;
second identification unit adapted to judge whether it is with or without a tracking error signal by performing focus-on on the data zone of the optical disc in response to the output that the tracking-on fails from the tracking control unit; and
discrimination unit adapted to judge that the optical disc is a blank disc that conforms to the DVD Download standards, based on an output from the first identification unit logically indicating that the optical disc is a DVD-ROM and the output from the second identification unit indicating absence of the tracking error signal.

14. The optical disc device according to claim 13, wherein among areas in the data zone of the optical disc, a start address area therein is subjected to the focus-on.

15. The optical disc device according to claim 13, wherein the tracking control unit controls to perform the tracking-on on the optical disc while moving in the radial direction thereof.

16. A program for causing an information processing device to realize functions of the first identification unit, the tracking control unit, the second identification unit, and the discrimination unit of the optical disc device according to claim 13 or 14 when the program is installed in the information processing device.

17. An optical disc discriminating method for discriminating types of loaded optical disc, characterized by
judging that the optical disc is a blank disc that conforms to DVD Download standards, if it is logically detected that the optical disc is a DVD-ROM based on information written in a lead-in zone of the optical disc and no tracking error signal is detected in the data zone, followed by detecting a wobble signal, and if it is also recognized that a wobble group is present in the optical disc.

18. The optical disc discriminating method according to claim 17, wherein
if no tracking error signal is detected in the data zone by a differential phase detection method, a push pull detection approach can be applied for detecting a wobble signal.

19. An optical disc device for recording and/or reproducing information in a loaded optical disc, characterized by comprising:
first identification unit adapted to logically identify that the optical disc is a DVD-ROM based on information written in a lead-in zone of the optical disc;
second identification unit adapted to detect a tracking error signal in a data zone of the optical disc by a differential phase detection method when the first identification unit logically identifies that the optical disc is a DVD-ROM;
third identification unit adapted to detect a wobble signal in the data zone by a push pull detection approach when the second identification unit detects no tracking error signal; and
discrimination unit adapted to discriminate that the optical disc is a blank disc that conforms to the DVD Download standards when the third identification unit detects the wobble signal.

20. A program for causing an information processing device to realize functions of the first identification unit, the second identification unit, the third identification unit, and the discrimination unit of the optical disc device according to claim 19 when the program is installed in the information processing device storage unit.
